(19) United States
(12) Patent Application Publication
(10) Pub. No.: US 2012/0262416 A1
(43) Pub. Date: Oct. 18, 2012

(54) ELECTRONIC DEVICE AND CONTROL METHOD

(75) Inventor: Yasushi KITAMURA, Yokohama-shi (JP)

(73) Assignee: KYOCERA CORPORATION, Kyoto (JP)

(21) Appl. No.: 13/448,545

(22) Filed: Apr. 17, 2012

(30) Foreign Application Priority Data
Apr. 18, 2011 (JP) 2011-092401

(51) Int. Cl. G06F 3/045; G06F 3/041

(52) U.S. Cl. 345/174; 345/173

(57) ABSTRACT

According to an aspect, an electronic device includes a first touch sensor, a second touch sensor, and control unit. The first touch sensor detects a contact in an active state. The second touch sensor detects a contact in a sleep state with a power consumption lower than that of the first touch sensor. The control unit switches from the sleep state to the active state when a contact is detected by the second touch sensor.

### CROSS-REFERENCE TO RELATED APPLICATIONS

This application claims priority from Japanese Application No. 2011-092401, filed on Apr. 18, 2011, the content of which is incorporated by reference herein in its entirety.

### BACKGROUND

1. Technical Field

The present disclosure relates to an electronic device with a touch panel and a control method thereof.

2. Description of the Related Art

Recently, touch panels in which a touch sensor and a display unit are laminated are proposed as an input device. Among the touch panels, some touch panel can detect a plurality of contact points as described in, for example, JP-T-2008-544352.

Electronic devices with a touch panel switch to so-called a sleep state when the operation is not detected for a given period of time. In the sleep state, the touch panel does not display any image and does not detect any operation performed thereon. Some of such electronic devices include a mechanical switch for receiving an operation for resuming from the sleep state.

A user of the above-discussed electronic device with a touch panel and a mechanical switch has to operate the mechanical switch disposed in an area other than the touch panel when causing the electronic device to resume from the sleep state. This causes operability to decrease.

The electronic device can be configured such that an operation performed on the touch sensor can be detected even in the sleep state. However, such a configuration causes the touch sensor to operate all the time, which results in an increase of power consumption.

For the foregoing reasons, there is a need for an electronic device with and high operability and a low power consumption and a control method thereof.

### SUMMARY

According to an aspect, an electronic device includes a first touch sensor, a second touch sensor, a display unit, and control unit. The first touch sensor detects a contact in an active state. The second touch sensor detects a contact in a sleep state with a power consumption lower than that of the first touch sensor. The second touch sensor is laminated to the first touch sensor. The display unit is configured to display information in the active state and not to display information in the sleep state. The display unit is laminated to the first touch sensor or the second touch sensor. The control unit switches from the sleep state to the active state when a contact is detected by the second touch sensor.

According to another aspect, an electronic device includes a first touch sensor, a second touch sensor, and control unit. The first touch sensor detects a contact in an active state. The second touch sensor detects a contact in a sleep state with a power consumption lower than that of the first touch sensor. The control unit switches from the sleep state to the active state when a contact is detected by the second touch sensor.

According to another aspect, a control method is a method for controlling an electronic device including a first touch sensor and a second touch sensor. The control method includes: driving the first touch sensor for detecting a contact in an active state; driving the second touch sensor for detecting a contact in a sleep state with a power consumption lower than that of the first touch sensor; and switching from the sleep state to the active state when a contact is detected by the second touch sensor.

### BRIEF DESCRIPTION OF THE DRAWINGS

FIG. 1 is a front view of a mobile phone;

FIG. 2 is an explanatory diagram of a schematic configuration of a touch panel;

FIG. 3 is an explanatory diagram of a schematic configuration of a first touch sensor;

FIG. 4 is an explanatory diagram of a schematic configuration of a second touch sensor;

FIG. 5 is a block diagram of the mobile phone;

FIG. 6 is a flowchart of an example of processes performed when the mobile phone detects an operation;

FIG. 7 is an explanatory diagram of a schematic configuration of a surface of the second touch sensor;

FIG. 8 is an explanatory diagram of a schematic configuration of a surface of the second touch sensor according to another embodiment;

FIG. 9 is an explanatory diagram of a schematic configuration of a surface of the second touch sensor according to another embodiment;

FIG. 10 is an explanatory diagram for explaining operations when the second touch sensor illustrated in FIG. 9 detects an operation; and

FIG. 11 is an explanatory diagram of a schematic configuration of the touch panel according to another embodiment.

### DETAILED DESCRIPTION

Exemplary embodiments of the present invention will be explained in detail below with reference to the accompanying drawings. It should be noted that the present invention is not limited by the following explanation. In addition, this disclosure encompasses not only the components specifically described in the explanation below, but also those which would be apparent to persons ordinarily skilled in the art, upon reading this disclosure, as being interchangeable with or equivalent to the specifically described components.

In the following description, a mobile phone is used to explain as an example of the electronic device; however, the present invention is not limited to mobile phone terminals. Therefore, the present invention can be applied to any type of devices provided with a touch panel, including but not limited to personal handyphone systems (PHS), personal digital assistants (PDA), portable navigation units, personal computers (including but not limited to tablet computers, netbooks etc.), media players, portable electronic reading devices, and gaming devices.

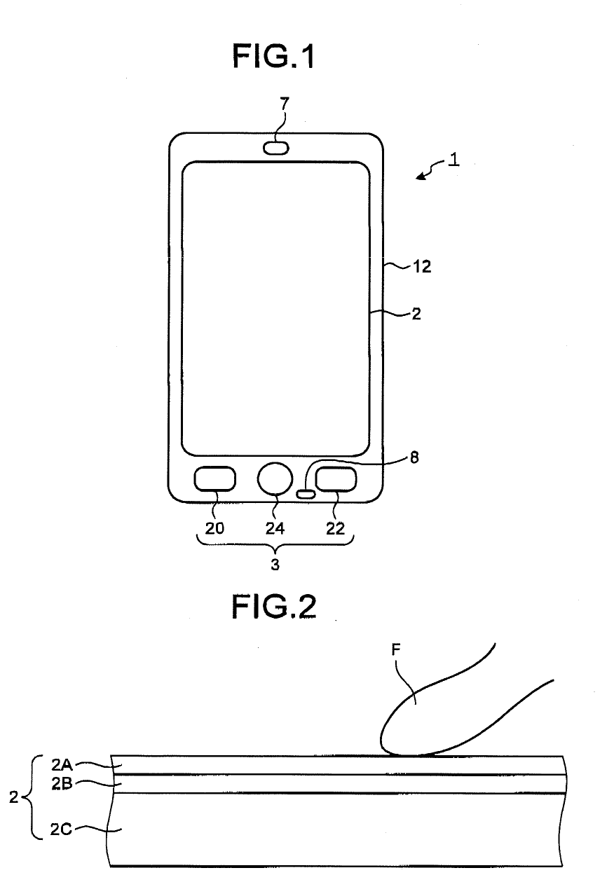

FIG. 1 is a front view of a mobile phone 1 which is an embodiment of an electronic device according. The mobile phone 1 includes a thin plate-like housing 12. The mobile phone 1 includes a touch panel 2; an input unit 3 including a button 20, a button 22, and an input device 24; a receiver 7; and a microphone 8, which are arranged on the surface of the housing 12. The touch panel 2 is provided over one of faces with the widest area of the plate-like housing 12. The input unit 3 is also disposed at one end of the face of the housing 12, in its long-side direction, where the touch panel 2 is provided. The button 20, the input device 24, and the button 22 are arranged in the input unit 3 in this order from one end toward the other end in its short-side direction. The receiver 7 is disposed at the other end of the face of the housing 12, in the long-side direction, where the touch panel 2 is provided, that is, at the opposite end to the end where the input unit 3 is disposed. The microphone 8 is disposed at one end of the face of the housing 12, in the long-side direction, where the touch panel 2 is provided, that is, at the end where the input unit 3 is disposed.

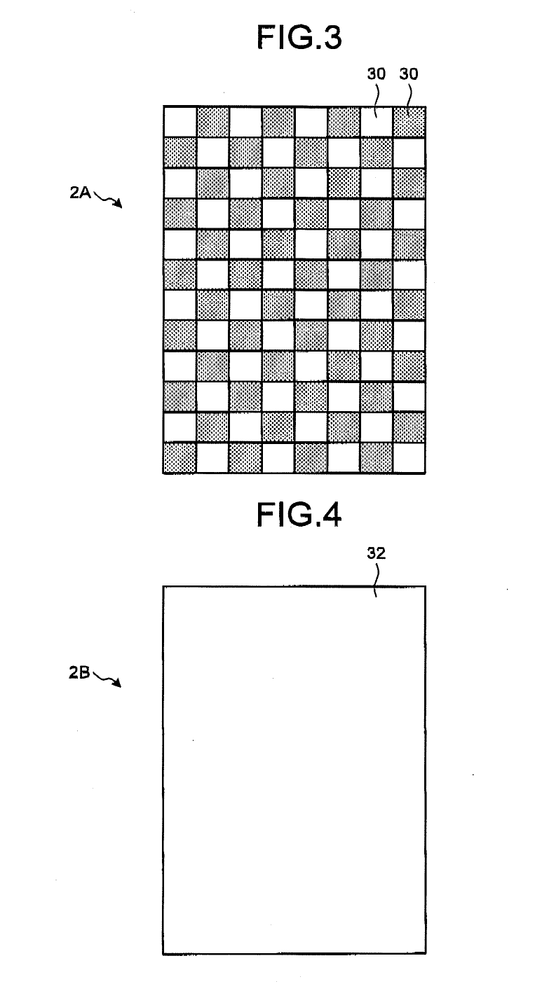

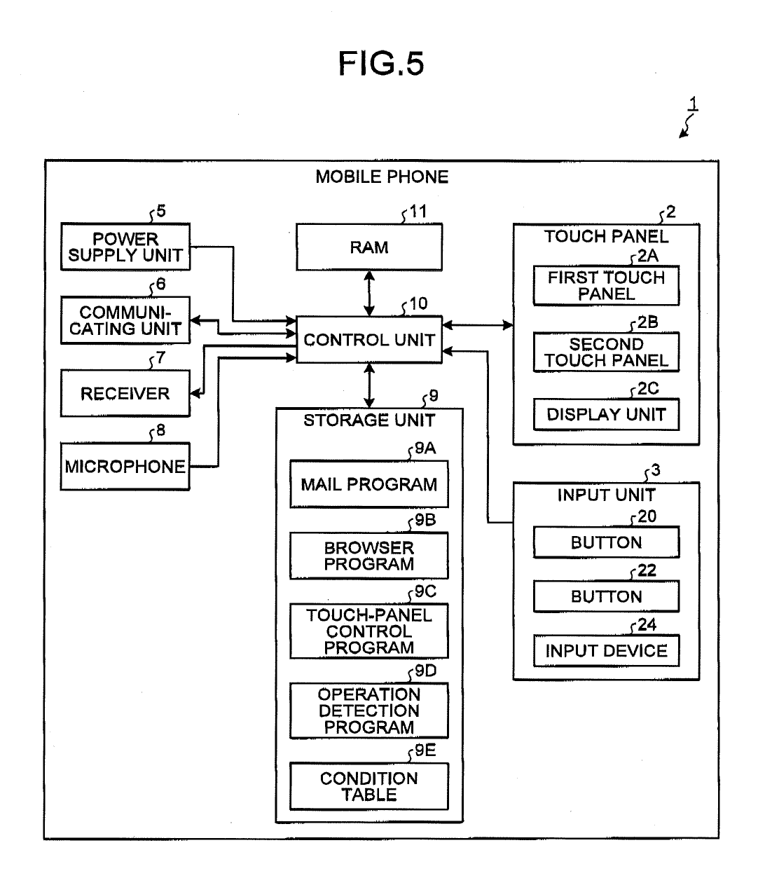

The touch panel 2 will be explained below with reference to FIG. 2 to FIG. 4. FIG. 2 is an explanatory diagram of a schematic configuration of the touch panel. FIG. 3 is an explanatory diagram of a schematic configuration of a first touch sensor. FIG. 4 is an explanatory diagram of a schematic configuration of a second touch sensor.

The touch panel 2 displays characters, graphics, images, and so on, and detects any of various operations performed on the touch panel 2 using a finger, a stylus, a pen (a tip of a pen, a tip of a rod-shaped member) or so (in the description herein below, for the sake of simplicity, it is assumed that the user touches the touch panel 2 with his/her finger(s)). For example, to receive an input of a character from a user, the mobile phone 1 displays a virtual keyboard on the touch panel 2. The mobile phone 1 enables a character input by detecting any of the operations input to the touch panel 2 with the finger and detecting which key of the virtual keyboard is pressed or touched while the virtual keyboard is displayed on the touch panel 2, and determining that a key detected as being pressed or touched is a key used for the input. Besides the input of the character, the touch panel 2 detects each input of various operations based on a displayed image and various operations performed on the touch panel 2 with the finger, and provides various controls based on the input operation.

As illustrated in FIG. 2, the touch panel 2 includes a first touch sensor 2A, a second touch sensor 2B, and a display unit 2C. As for the touch panel 2, the first touch sensor 2A, the second touch sensor 2B, and the display unit 2C are layered in this order from the outside of the housing 12 toward the inside thereof. That is, the touch panel 2 is provided in such a manner that the second touch sensor 2B is sandwiched between the first touch sensor 2A and the display unit 2C. In this way, the touch panel 2 has a configuration so that the first touch sensor 2A is provided on the outermost side (outer side of the housing 12; exposed face) and the display unit 2C is provided in the innermost side (inner side of the housing 12). The second touch sensor 2B is provided closer to the display unit 2C side than the first touch sensor 2A.

The first touch sensor 2A is a plate-like member, and detects various operations performed on the touch panel 2 using a finger F as well as with positions on the touch panel 2 where the operations are performed. The operation detected by the touch sensor 2A includes, for example, an operation of touching the surface of the touch panel 2 with the finger, an operation of moving the finger while keeping in contact with the surface of the touch panel 2, and an operation of releasing the finger from the surface of the touch panel 2.

The touch sensor 2A can adopt any of touch sensors using various detection methods such as a resistive type detection method, a pressure sensitive type detection method, a capacitive type detection method, and a surface acoustic wave type detection method. The first touch sensor 2A is provided with electrodes 30 arranged in a matrix as illustrated in FIG. 3. The electrodes 30 detect a position on the touch panel 2 where an operation is performed as illustrated in FIG. 2, in other words, a contact position. In the first touch sensor 2A, various operations are performed on the touch panel 2 using the finger, and a detected value of the electrode 30 at a position contacted through any of the operations thereby changes. The first touch sensor 2A detects the contact position based on the position of the electrode 30 whose detected value changes. In FIG. 3, to make easy to understand the layout of the electrodes 30 of the first touch sensor 2A, the electrodes 30 are illustrated in a 12-row 8-column matrix; however, the number of rows and the number of columns are not specifically limited. The first touch sensor 2A can detect the contact position with a higher precision by increasing the numbers of rows and columns, that is, by enhancing resolution.

The second touch sensor 2B is a plate-like member whose area is nearly the same as that of the first touch sensor 2A, and is laminated to the first touch sensor 2A so that both the surfaces whose areas are the largest (main surfaces) overlap each other. The second touch sensor 2B detects a contact operation performed on the touch panel 2 using the finger F. This enables the second touch sensor 2B to detect the contact operation in the same area as an area where a contact can be detected by the first touch sensor 2A. Though the second touch sensor 2B comes in contact with the finger F via the first touch sensor 2A, the second touch sensor 2B detects a physical property value of the first touch sensor 2A that changes according to the contact by the finger F, and thereby detects the contact operation. The second touch sensor 2B can adopt any of touch sensors using various detection methods such as a resistive type detection method, a pressure sensitive type detection method, a capacitive type detection method, and a surface acoustic wave type detection method. The second touch sensor 2B is provided with an electrode 32 for detecting a contact as illustrated in FIG. 4. That is, the second touch sensor 2B is provided with the electrode 32 whose area is larger than that of the electrode 30 of the first touch sensor 2A. Because there is one unit as the electrode 32 being an element for detecting a touch, the second touch sensor 2B according to the present embodiment detects a contact operation performed on the touch panel 2 but does not detect a contact position. In other words, in the second touch sensor 2B, because the resolution is 1, it is detected only whether the contact operation is performed. In this way, the second touch sensor 2B detects the contact operation with a lower resolution (lower sensitivity) than that of the first touch sensor 2A.

The display unit 2C is formed from, for example, a liquid crystal display (LCD) or an organic electro-luminescence display (OELD), and displays characters, graphics, images, and so on.

When the button 20 or 22 is pressed, the input unit 3 activates a function corresponding to the pressed button. The input unit 3 detects an action input to the input device 24 as an operation, and performs various controls based on the input operation. For example, the input device 24 detects a direction indicating operation and a determining operation. The input device 24 is formed from a touch pad, an optical input device, an input device that includes buttons at a central portion and in four directions, or the like.

Next, a relation between functions and a control unit of the mobile phone 1 will be explained below. FIG. 5 is a block diagram of the mobile phone 1 illustrated in FIG. 1. The mobile phone 1 includes the touch panel 2, the input unit 3, a power supply unit 5, a communicating unit 6, a receiver 7, a microphone 8, a storage unit 9, a control unit 10, and a random access memory (RAM) 11.

As explained above, the touch panel 2 includes the first touch sensor 2A, the second touch sensor 2B, and the display unit 2C. The touch panel 2 is driven based on the control of the control unit 10. The first touch sensor 2A and the second touch sensor 2B detect a contact operation performed on the touch panel 2. When the first touch sensor 2A or the second touch sensor 2B is a capacitive type sensor, explained later, the operation can be detected when a change in capacitance caused by approach of an object exceeds a predetermined threshold even if the object does not come in contact with the first touch sensor 2A or the second touch sensor 2B. When a function of detecting a contact operation is stopped, the first touch sensor 2A and the second touch sensor 2B do not detect the contact operation even if the contact operation is performed on the touch panel 2. The first touch sensor 2A and the second touch sensor 2B transmit a signal corresponding to the detected contact operation to the control unit 10. The display unit 2C displays an image based on the signal supplied from the control unit 10.

The input unit 3 includes the buttons 20 and 22, and the input device 24 as explained above. The buttons 20 and 22 receive a user's operation through a physical input (pressing) and transmit a signal corresponding to the received operation to the control unit 10. The input device 24 also receives a user's operation and transmits a signal corresponding to the received operation to the control unit 10.

The power supply unit 5 supplies electric power obtained from a buttery or an external power supply to the function units of the mobile phone 1 including the control unit 10. The communicating unit 6 establishes a wireless signal path using a code-division multiple access (CDMA) system, or any other wireless communication protocols, with a base station via a channel assigned by the base station, and performs telephone communication and information communication with the base station. Any other wired or wireless communication or network interfaces, e.g., LAN, Bluetooth, Wi-Fi, NFC (Near Field Communication) may also be included in lieu of or in addition to the communicating unit 6. The receiver 7 outputs voice of the other party on the telephone communication, a ring tone, and the like. The microphone 8 converts the voice of the user or so to electrical signals.

The storage unit 9 includes one or more non-transitory storage medium, for example, a nonvolatile memory (such as ROM, EPROM, flash card etc.) and/or a storage device (such as magnetic storage device, optical storage device, solid-state storage device etc.), and stores therein programs and data used for processes performed by the control unit 10. Specifically, the storage unit 9 stores therein a mail program 9A for transmitting, receiving and browsing mail, a browser program 9B for browsing Web pages, a touch-panel control program 9C for controlling the operation of the touch panel 2, an operation detection program 9D for detecting an input detected by the touch panel 2 or by the input unit 3 as an operation, and a condition table 9E in which various conditions used to execute the various programs are associated with each other. The storage unit 9 also stores therein an operating system program for performing basic functions of the mobile phone 1, and other programs and data such as address book data in which names, telephone numbers, mail addresses, and so on are registered. In addition, the storage unit 9 stores therein programs that determine a control operation and a process based on an input operation input to the touch panel 2. The control operation and the process include various operations and processes implemented by the mobile phone 1, which are, for example, movement of a cursor and a pointer, display switching between screens, a character input process, and an activation process and an termination process of various applications.

Moreover, the storage unit 9 stores therein first information and second information in an associated manner. The first information includes a positional relation between a reference position on the second touch sensor 2B and a position of an operation performed on the second touch sensor 2B. The second information includes positional relation between a plurality of screens which can be displayed on the display unit. The storage unit 9 can use various areas as an area where the first information and the second information are stored, and can store them in, for example, the condition table 9E. Screen control based on the first information and the second information will be explained in detail later.

The control unit 10 is, for example, a central processing unit (CPU), and integrally controls the operations of the mobile phone 1. Specifically, the control unit 10 executes a program stored in the storage unit 9 while referring to data stored in the storage unit 9 as necessary, and executes the various processes by controlling the touch panel 2, the input unit 3, the communicating unit 6, and so on. The control unit 10 loads data, which is acquired, generated, or processed by executing the programs and the processes stored in the storage unit 9, to the RAM 11 providing a temporary storage area as necessary. The programs executed by the control unit 10 and the data to be referred to may be downloaded from a server through a wireless communication by the communicating unit 6.

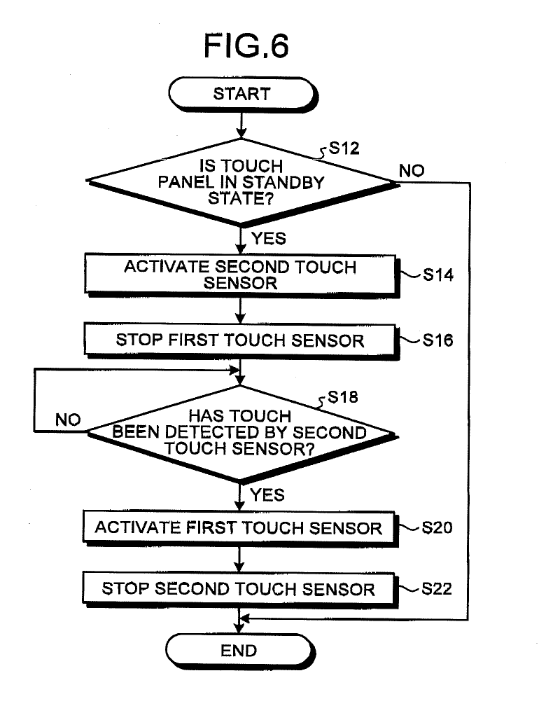

Next, an example of processing operation when a contact operation performed on the touch panel 2 is detected by the control unit 10 of the mobile phone 1 will be explained with reference to FIG. 6. FIG. 6 is a flowchart of an example of processes performed when the mobile phone 1 detects an operation. The procedure illustrated in FIG. 6 is repeatedly executed based on the functions provided by the touch-panel control program 9C and the operation detection program 9D. More specifically, the control unit 10 acquires various detection results by the function provided by the touch-panel control program 9C and analyses the detection results based on the function provided by the operation detection program 9D to detect an input operation.

The control unit 10 of the mobile phone 1 determines whether the touch panel is in a standby state, that is, in a sleep state, at Step S12. The control unit 10 causes the touch panel 2 to be switched to the sleep state when a predetermined condition is satisfied, for example, when a user's operation is not input for a given time or more. The sleep state is a state in which a partial function is stopped although a main power supply of the mobile phone 1 is on and power consumption is thereby suppressed. The control unit 10 causes the display unit 32 of the touch panel 2 not to display a screen (image) when in the sleep state.

When it is determined at Step S12 that the touch panel is not in the standby state (No), that is, not in the sleep state (active state), the control unit 10 ends the present process. The active state is a state in which various functions are activated. When in the active state, the control unit 10 causes the display unit 32 of the touch panel 2 to display a screen (image). The operation of the touch panel 2 in the active state will be explained later.

When it is determined at Step S12 that the touch panel is in the standby state (Yes), that is, in the sleep state, the control unit 10 activates the second touch sensor 2B at Step S14, and stops the first touch sensor 2A at Step S16. That is, the control unit 10 controls such that the contact operation performed on the touch panel 2 is detectable by the second touch sensor 2B. By stopping the supply of the electric power to various types of circuits which have been driven to detect a contact operation using the first touch sensor 2A, the control unit 10 stops the first touch sensor 2A. The control unit 10 may reverse the order of the process at Step S14 and the process at Step S16, or may perform the processes simultaneously.

Thereafter, the control unit 10 determines whether the second touch sensor 2B has detected a contact (contact operation), at Step S18. That is, the control unit 10 determines, using the second touch sensor 2B, whether an operation has been input to the touch panel 2 in the sleep state. When it is determined at Step S18 that the contact has not been detected (No), the control unit 10 proceeds to Step S18. That is, when in the sleep state, the control unit 10 repeats the process at Step S18 until the second touch sensor 2B detects a contact operation.

When it is determined at Step S18 that the contact has been detected (Yes), the control unit 10 switches from the sleep state to the active state. Specifically, the control unit 10 activates the first touch sensor 2A at Step S20, and stops the second touch sensor 2B at Step S22. That is, the control unit 10 controls such that the contact operation performed on the touch panel 2 is detectable by the first touch sensor 2A. The control unit 10 stops the supply of the electric power to the various circuits which have been driven to detect the contact operation using the second touch sensor 2B, to thereby stop the second touch sensor 2B. The control unit 10 may reverse the order of the process at Step S20 and the process at Step S22, or may perform the processes simultaneously. The control unit 10 also performs the process for displaying the screen on the display unit 2C together with the process at Step S20 and the process at Step S22. The control unit 10 performs the process at Step S20 and the process at Step S22 and switches the touch panel 2 to its active state, and then ends the present process.

In this way, the mobile phone 1 can improve operability while suppressing power consumption, by providing the first touch sensor 2A and the second touch sensor 2B on the touch panel 2, detecting the contact operation using the second touch sensor 25 when in the sleep state, and detecting the contact operation using the first touch sensor 2A when in the active state in which the various processes are executed. That is, even when in the sleep state, the second touch sensor 2B detects the contact operation performed on the touch panel 2, and the user touches the touch panel 2, so that the touch panel 2 can be switched to the active state. Thus, the operability can be improved. Moreover, by setting the resolution of the second touch sensor 2B to be lower than the resolution of the first touch sensor 2A, the mobile phone 1 can reduce an increase in power consumption even if the second touch sensor 2B detects the contact operation in the sleep state.

If a predetermined time has elapsed without any operation performed on the first touch sensor 2A, by switching to the sleep state, the control unit 10 can reduce the power consumption as explained above.

When in the active state, it is configured not to detect the contact operation using the second touch sensor 2B, that is, to stop the second touch sensor 2B, and therefore the control unit 10 can suppress an increase in the power consumption of the touch panel 2. When in the active state, the first touch sensor 2A detects the contact operation, and therefore the mobile phone 1 can detect the contact operation performed on the touch panel 2 even if the second touch sensor 25 is stopped. In this way, by switching between the touch sensor to be activated and the touch sensor to be stopped when in the active state and in the sleep state, the operability can be improved while the power consumption is suppressed.

In the present embodiment, as the configuration in which the resolution of the second touch sensor 2B is lower than the resolution of the first touch sensor 2A in the touch panel 2, the configuration in which the second touch sensor 2B detects only whether the contact operation is performed is used as an example to explain; however, the present invention is not limited thereto. The touch panel 2 has only to be any touch panel in which the second touch sensor 2B detects an operation with a power consumption lower than that of the first touch sensor 2A. For example, when the first touch sensor 2A and the second touch sensor 2B use the same type of touch sensor, grating density (layout density of electrodes) of the second touch sensor 2B is configured to be lower than grating density (layout density of electrodes) of the first touch sensor 2A, then the second touch sensor 2B operates with a power consumption lower than that of the first touch sensor 2A. If the area of the second touch sensor 2B is smaller than the area of the first touch sensor 2A, then the second touch sensor 2B operates with a lower power consumption. In other words, the first touch sensor 2A and the second touch sensor 2B do not need to have the same area, and may therefore have a different area from each other.

As explained in the present embodiment, the second touch sensor 2B is provided closer to the display unit 2C side than the first touch sensor 2A, so that the touch panel 2 can maintain detection sensitivity of the first touch sensor 2A when the contact operation is detected in the active state. In other words, the touch panel 2 can prevent the second touch sensor 2B from affecting on the sensitivity of the first touch sensor 2A.

The locations where the first touch sensor 2A and the second touch sensor 2B are provided are not limited thereto. The touch panel 2 may have the first touch sensor 2A that is closer to the display unit 2C side than the second touch sensor 2B. That is, the touch panel 2 may have the second touch sensor 2B provided on a more outer side (the side exposed to the outside) of the housing 12 than the first touch sensor 2A. By placing the first touch sensor 2A closer to the display unit 2C side than the second touch sensor 2B, the touch panel 2 can adequately detect the contact operation using the second touch sensor 2B.

The touch panel 2 can be provided with various types of touch sensors as the first touch sensor 2A and the second touch sensor 2B. For example, the touch panel 2 can be provided with a projected capacitive type touch sensor (touch screen) as the first touch sensor 2A and a projected capacitive type touch sensor (touch screen) as the second touch sensor 2B.

The touch panel 2 can be configured so that a projected capacitive type touch sensor (touch screen) is used as the first touch sensor 2A and a surface capacitive type touch sensor (touch screen) is used as the second touch sensor 2B. In this case, the second touch sensor 2B is preferably provided on a more outer side of the housing 12 than the first touch sensor 2A.

The touch panel 2 can also be configured so that a capacitive type touch sensor (touch screen) is used as the first touch sensor 2A and a resistive type touch sensor is used as the second touch sensor 2B. By using a resistive type touch sensor with less power consumption as the second touch sensor 2B, the power consumption in the second touch sensor 2B can be reduced. An operation for resistive type touch sensor requires a predetermined pressure force, and therefore an operation that is not intended by the user can be made harder to be detected in the sleep state. In this case, the second touch sensor 2B is preferably provided on a more outer side of the housing 12 than the first touch sensor 2A.

The touch panel 2 can be configured so that a capacitive type touch sensor (touch screen) is used as the first touch sensor 2A and a surface acoustic wave type touch sensor (touch screen) is used as the second touch sensor 2B. In this case, the second touch sensor 2B is preferably provided on a more outer side of the housing 12 than the first touch sensor 2A.

As explained above, the touch panel 2 can be configured by a combination of various touch sensors. If a resistive type touch sensor is used as one of the touch sensors, the resistive type touch sensor is preferably provided on a more outer side of the housing 12 than the other touch sensor. This enables the resistive type touch sensor to adequately detect the contact operation.

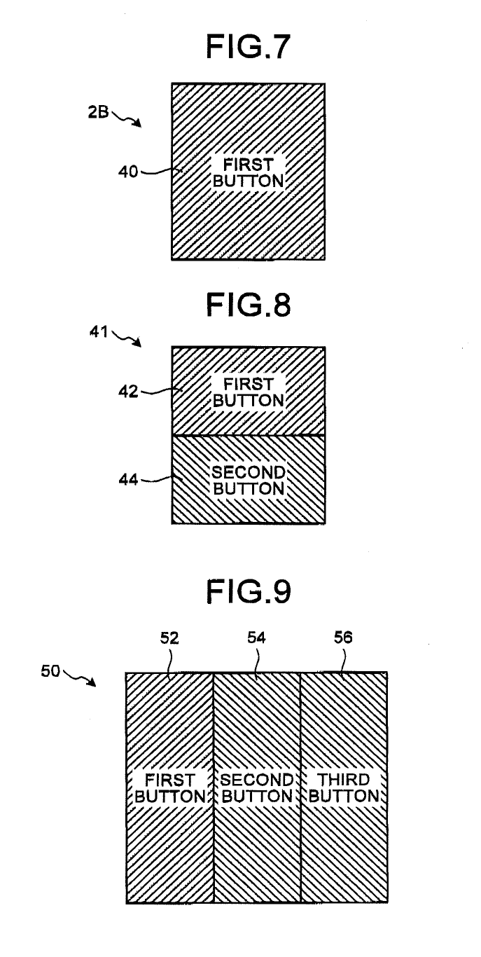

FIG. 7 is an explanatory diagram of a schematic configuration of a surface of the second touch sensor. The mobile phone 1 may be handled as if the entire surface of the second touch sensor 2B is one button (first button) 40 as illustrated in FIG. 7, that is, the resolution is 1. In this configuration, the second touch sensor 2B has only to include a circuit for detecting a contact operation, and a circuit for detecting a contact position does not need to be provided, thus further reducing power consumption required when the contact operation is detected.

The second touch sensor is not limited to the configuration provided with one button 40. Each of FIG. 8 and FIG. 9 is an explanatory diagram of a schematic configuration of a surface of the second touch sensor according to another embodiment. A second touch sensor 41 illustrated in FIG. 8 is configured to vertically divide an area where a touch is detected into two areas, so that two buttons are set. Specifically, the second touch sensor 41 sets an upper half area, of the area where a touch is detected, to a button (first button) 42, and sets a lower half area, of the area where a touch is detected, to a button (second button) 44. A second touch sensor 50 illustrated in FIG. 9 is configured to horizontally divide an area where a touch is detected into three areas, so that three buttons are set. Specifically, the second touch sensor 50 sets the left one-third of the area, where a touch is detected, to a button (first button) 52, the center one-third of the area to a button (second button) 54, and the right one-third of the area to a button (third button) 56.

The area of the second touch sensor of the touch panel is divided into a plurality of areas as illustrated in FIG. 8 and FIG. 9 and each of the divided areas is handled as a button (operating unit), so that the mobile phone 1 can detect which area is touched. In the present embodiment, a center point of the second touch sensor is set as the reference position in the second touch sensor. In the configuration illustrated in FIG. 8, the reference position is present along a boundary between the first button 42 and the second button 44. In the configuration illustrated in FIG. 9, the reference position is present in an area (center one-third of the area) assigned to the second button 54. The reference position of the second touch sensor is not limited to the center point of the second touch sensor, and may therefore be a position different from the center point. The reference position may be an area having some amount of area instead of any point on the second touch sensor.

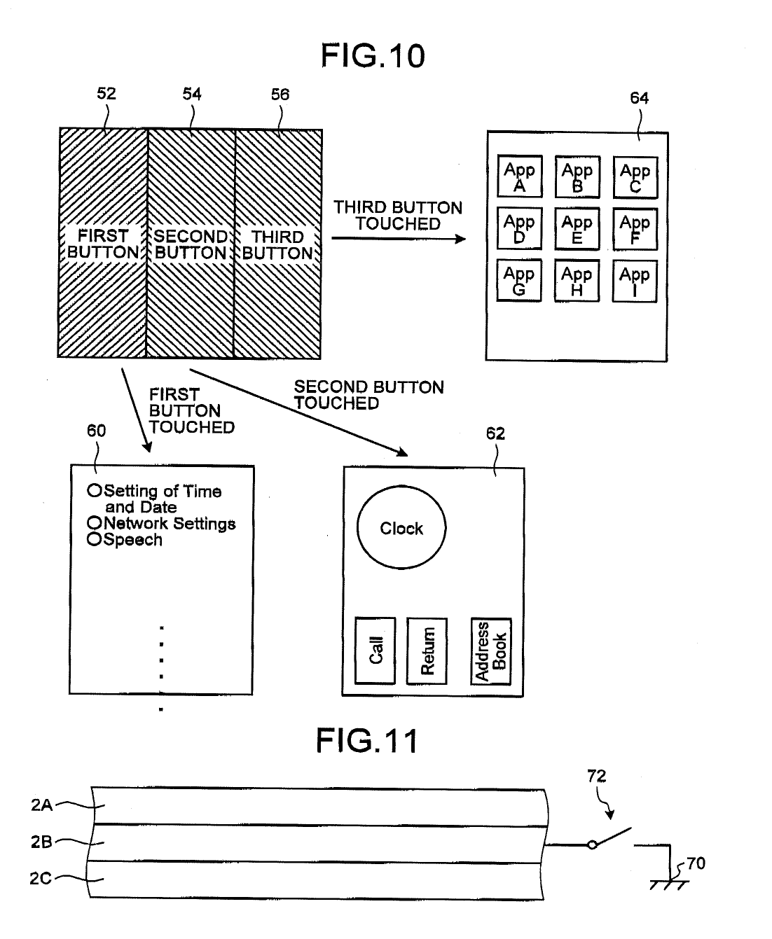

An example of a relation between a button contacted upon sleep and a screen displayed on the display unit upon resume will be explained below with reference to FIG. 10. FIG. 10 is an explanatory diagram for explaining operations when the second touch sensor 50 illustrated in FIG. 9 detects an operation. When the second touch sensor detects a contact with the button (first button) 52 in the sleep state, the control unit 10 of the mobile phone 1 displays a screen 60. The screen 60 is used to perform various settings. When the second touch sensor detects a contact with the button (second button) 54 in the sleep state, the control unit 10 displays a screen 62. The screen 62 is a home screen. The home screen includes a standby screen. The standby screen is a screen when incoming and outgoing calls are awaited or is a screen when activation of an application program is awaited. In other words, the standby screen is a screen before the screen is changed to a screen with various functions provided by the mobile phone 1. The standby screen is sometimes called, for example, an initial screen, a desktop screen, a home screen, or a wall paper. In the example illustrated in FIG. 10, a blank screen is displayed as the standby screen; however, image data and animation data may be displayed as the standby screen. The standby screen may include a dynamically changing portion such as a calendar and a clock. Displayed on the screen 62 according to the present embodiment are an image of a clock, a button associated with a calling operation, a button associated with a returning operation, and a button associated with an operation for displaying an address book. When the second touch sensor detects a contact with the button (third button) 56 in the sleep state, the control unit 10 of the mobile phone 1 displays a screen 64. The screen 64 is used to display icons of installed applications.

In this manner, the mobile phone 1 can be configured so that the second touch sensor determines which button is contacted by a contact operation, and so that the mobile phone 1 execute a process corresponding to the contacted button when switching from the sleep state to the active state. Thus, the screen displayed upon resume from the sleep state can be set to various screens, which enables the user to input an operation of resuming the screen and an operation of switching between display screens at one operation. Moreover, even when the second touch sensor is divided into a plurality of areas, by dividing the area into predetermined set areas, a circuit that determines which area is a touched area can be simplified. In other words, the second touch sensor can perform the process even if detection precision of a contact position is made lower than that of the first touch sensor. Therefore, even if determination of the touched button is performed, the operability can be improved while power consumption is suppressed.

Some mobile phones can switch a screen to be displayed among a plurality of different screens according to a drag operation or a flick operation performed on the touch panel. In such a mobile phone as above, the control unit 10 may associate the contacted button with the screen to be displayed upon switching from the sleep state to the active state. When the position of the contact operation detected by the second touch sensor is included in the area of the third button 56 (on the right side with respect to the reference position), the control unit 10 may set a screen to be displayed at the time of switching from the sleep state to the active state, to the right-side screen of the screen displayed on the display unit before switching to the sleep state. When the position of the contact operation detected by the second touch sensor is included in the area of the first button 52 (on the left side with respect to the reference position), the control unit 10 may set a screen to be displayed at the time of switching from the sleep state to the active state, to the left-side screen of the screen displayed on the display unit before switching to the sleep state. That is, a screen corresponding to a direction of a pressed button viewed from the center may be displayed. This enables the user to select a screen to be displayed upon resume.

When the screen displayed on the display unit before switching to the sleep state is the right-edge screen of the screens and the position of the contact operation detected by the second touch sensor is on the right side, the control unit 10 sets a screen to be displayed at the time of switching from the sleep state to the active state, to the screen displayed on the display unit before switching to the sleep state. Meanwhile, when the screen displayed on the display unit before switching to the sleep state is the left-edge screen of the screens and the position of the contact operation detected by the second touch sensor is on the left side, the control unit 10 sets a screen to be displayed at the time of switching from the sleep state to the active state, to the screen displayed on the display unit before switching to the sleep state. That is, if there is no screen to be further shifted from the screen set to be displayed, the control unit 10 may display again the screen displayed on the display unit before switching to the sleep state. This enables the user to recognize that the screen at the end of the display sequence is displayed.

When the screen displayed on the display unit before switching to the sleep state is the right-edge/left-edge (far right or far left) screen of the screens and the position of the contact operation detected by the second touch sensor is on the right side/left side (far right or far left, that is, an edge side of the screen), the control unit 10 can also set a screen to be displayed at the time of switching from the sleep state to the active state, to the screen set as the reference among the screens. In other words, when the screen set to be displayed is a screen at an edge and an operation of shifting the screen to an outer side of the edge is further input, the control unit 10 may display the screen (e.g., home screen) set as the reference. This enables the user to easily recognize the sequence of the screens.

The control unit 10 can also set a screen to be displayed at the time of switching from the sleep state to the active state, to a specific screen regardless of positions where an operation is detected by the second touch sensor 2B. In this way, by setting such that the same screen is always displayed at the time of resuming, the operation can be started without being affected by the previous operation.

FIG. 11 is an explanatory diagram of a schematic configuration of the touch panel according to another embodiment. The mobile phone 1 may include a reference potential point 70 and a switch circuit 72 that switches a connection between the second touch sensor 2B and the reference potential point 70, as illustrated in FIG. 11. The touch panel illustrated in FIG. 11 is configured to provide the second touch sensor 2B between the first touch sensor 2A and the display unit 2C. The reference potential point 70 is a so-called ground. The switch circuit 72 is a circuit that switches between a state where the second touch sensor 2B and the reference potential point 70 are electrically connected to each other and a state where they are not connected to each other. The switch circuit 72 electrically connects the second touch sensor 2B and the reference potential point 70, so that the second touch sensor 2B is set to a reference potential.

When in the active state, the control unit 10 causes the switch circuit 72 to connect the second touch sensor 2B and the reference potential point 70. When in the sleep state, the control unit 10 causes the switch circuit 72 not to connect the second touch sensor 2B and the reference potential point 70. In this way, in the active state, the second touch sensor 2B and the reference potential point 70 are connected to each other by the switch circuit 72 and the second touch sensor 2B is set to the reference potential, so that the second touch sensor 2B can function as a shield between the first touch sensor 2A and the display unit 2C. Thus, by driving the first touch sensor 2A and the display unit 2C in the active state, noise caused by the drive of one side affecting on the drive of the other side can be suppressed. By making the second touch sensor 2B serve as a shield (noise shield) in this manner, occurrence of noise can be prevented without providing the noise shield in the first touch sensor 2A. In addition, the switch circuit 72 can be implemented with a simple mechanism, so that a low cost can be achieved. Moreover, the second touch sensor 2B is driven when in the sleep state in which the screen is not displayed on the display unit 2C, that is, the display unit 2C is stopped. Therefore, noise caused by the display unit 2C can be suppressed without providing the shield between the display unit 2C and the second touch sensor 2B.

The present embodiment has explained the example of the procedure when the control unit 10 detects the contact operation performed on the touch panel 2, with reference to FIG. 6. In the flowchart illustrated in FIG. 6, when the second touch sensor 2B has detected an operation in the sleep state (Yes at Step S18), the control unit 10 activates the first touch sensor 2A at Step S20 and stops the second touch sensor 2B at Step S22.

The finger (object: the user's finger or the stylus pen) with which the operation is performed at Step S18 may be present on the touch panel 2 when the control unit 10 activates the first touch sensor 2A at Step S20. Accordingly, for example, if the first touch sensor 2A is a capacitive type, a signal corresponding to the operation may be transmitted from the first touch sensor 2A to the control unit 10 based on the change in the capacitance due to the user's finger. In such a case, the control unit 10 may or may not perform a predetermined process based on the signal according to the operation received from the first touch sensor 2A. That is, when an operation is detected by the second touch sensor 2B in the sleep state and any operation is detected by the first touch sensor 2A at the time of being switched to the active state in which the first touch sensor 2A can detect an operation, the control unit 10 may set the detected operation to be active or to be inactive.

As the predetermined process, when the position of the operation detected by the first touch sensor 2A corresponds to an area assigned to an icon for activating a predetermined function displayed on the display unit 2C, the control unit 10 can perform the process for activating the predetermined function. If it is detected that the position of operation detected by the first touch sensor 2A is moved upon switching to the active state (which corresponds to, for example, a case where the user performs a drag operation or a flick operation), the control unit 10 may perform a process such as scrolling of a screen displayed on the display unit 2C based on the operation.

The control unit 10 may be configured to measure a time elapsed since the active state in which the display is performed by the display unit 2C and the operation is detected by the first touch sensor 2A, not to perform the predetermined process if the operation is not detected by the first touch sensor 2A before a predetermined time elapses since the active state, and to perform the predetermined process when the operation (touch) is detected by the first touch sensor 2A even after the predetermined time elapses since the active state.

When the operation is not detected before the predetermined time elapses since the active state, there may be a possibility in which the user does not intend to perform the operation, that is, the user performs the operation only for the purpose of merely switching from the sleep state to the active state. Meanwhile, when the operation is detected after the predetermined time elapses since the active state, there may be a possibility in which the user may intend to activate any one of the functions and perform an operation on the touch panel 2. Thus, by determining whether the predetermined process is performed according to the elapse of the time since the active state, user-friendliness can be improved.

When the operation is detected even after the elapse of the predetermined time since the active state, control unit 10 may detect the movement of the position where the operation is performed, and activate the function related to an icon corresponding to the position where the end of the operation is detected. With this feature, the user can activate a desired function by moving the finger up to an area where the icon corresponding to the desired function is displayed and by releasing the finger thereat, if the function related to the icon at the position touched with the finger is different from the function which the user desires to activate at the time of the display by the display unit 2C. This leads to further improvement of the user-friendliness.

The advantages are that one embodiment of the invention provides an electronic device with a high operability and a low power consumption and a control method thereof.

What is claimed is:

1. An electronic device comprising:
a first touch sensor for detecting a contact in an active state;
a second touch sensor for detecting a contact in a sleep state with a power consumption lower than that of the first touch sensor, the second touch sensor being laminated to the first touch sensor;
a display unit that is configured to display information in the active state and not to display information in the sleep state, the display unit being laminated to the first touch sensor or the second touch sensor; and
a control unit for switching from the sleep state to the active state when a contact is detected by the second touch sensor.

2. The electronic device according to claim 1, wherein,
the control unit is configured to switch, when a given time elapses without a detection of a contact by the first touch sensor in the active state, from the active state to the sleep state.

3. The electronic device according to claim 1, wherein the control unit is configured to cause the second touch sensor not to detect a contact in the active state.

4. The electronic device according to claim 1, wherein the second touch sensor is provided closer to the display unit side than the first touch sensor.

5. The electronic device according to claim 4, further comprising
a switch circuit for switching whether or not the second touch sensor is connected to a reference potential point, wherein
the control unit is configured to cause the switch circuit to connect the second touch sensor and the reference potential point in the active state.

6. The electronic device according to claim 1, wherein the first touch sensor is provided closer to the display unit side than the second touch sensor.

7. The electronic device according to claim 6, wherein the second touch sensor is a resistive type.

8. The electronic device according to claim 1, wherein the second touch sensor has a resolution lower than that of the first touch sensor.

9. The electronic device according to claim 1, wherein
the control unit is configured to determine a screen to be displayed on the display unit on switching from the sleep state to the active state, according to a contact position detected by the second touch sensor in the sleep state.

10. The electronic device according to claim 9, wherein
the display unit is configured to display one of ordered screens in such a manner that a screen displayed thereon is switched to a right side screen or a left side screen according to a contact operation detected by the first touch sensor, and
the control unit is configured to determine a first screen to be displayed on the display unit on switching from the sleep state to the active state among the screens, based on a relation between a second screen that has been displayed on the display unit on switching from the active state to the sleep state and the contact position.

11. The electronic device according to claim 10, wherein
the control unit is configured to
determine a right side screen of the second screen as the first screen when the contact position is on a right side with respect to a reference position, and
determine a left side screen of the second screen as the first screen when the contact position is on a left aide with respect to the reference position.

12. The electronic device according to claim 11, wherein
the control unit is configured to
determine a right-edge screen among the screens as the first screen when the contact position is on the right side with respect to the reference position and the second screen is the right-edge screen, and
determine a left-edge screen among the screens as the first screen when the contact position is on the left side with respect to the reference position and the second screen is the left-edge screen.

13. The electronic device according to claim 11, wherein
the control unit is configured to
determine a reference screen among the screens as the first screen when the contact position is on the right side with respect to the reference position and the second screen is the right-edge screen or when the contact position is on the left side with respect to the reference position and the second screen is the left-edge screen.

14. The electronic device according to claim 1, wherein
the control unit is configured to determine a reference screen among the screens as a screen to be displayed on the display unit on switching from the sleep state to the active state.

15. An electronic device comprising:
a first touch sensor for detecting a contact in an active state;
a second touch sensor for detecting a contact in a sleep state with a power consumption lower than that of the first touch sensor; and
a control unit for switching from the sleep state to the active state when a contact is detected by the second touch sensor.

16. A control method of an electronic device including a first touch sensor and a second touch sensor, the control method comprising:
driving the first touch sensor for detecting a contact in an active state;
driving the second touch sensor for detecting a contact in a sleep state with a power consumption lower than that of the first touch sensor; and
switching from the sleep state to the active state when a contact is detected by the second touch sensor.
